(19) United States
(12) Patent Application Publication
(10) Pub. No.: US 2013/0233251 A1
(43) Pub. Date: Sep. 12, 2013

(54) ANIMAL MEDICAL FLUID LINE HARNESS

(71) Applicants: Walter K. Borgan, West St. Paul, MN (US); Kimberly M. Borgan, West St. Paul, MN (US)

(72) Inventors: Walter K. Borgan, West St. Paul, MN (US); Kimberly M. Borgan, West St. Paul, MN (US)

(21) Appl. No.: 13/772,420

(22) Filed: Feb. 21, 2013

Related U.S. Application Data
(60) Provisional application No. 61/685,004, filed on Mar. 9, 2012.

(51) Int. Cl. A61D 7/00

(52) U.S. Cl. CPC A61D 7/00
USPC 119/712

(57) ABSTRACT

An animal fluid line holder that includes an animal attachment portion and a fluid line engaging portion. The animal attachment portion includes an elongated section, a fastening mechanism that is capable of engaging opposite ends of the elongated section and a first engagement mechanism attached to the elongated section. The fluid line attachment portion includes a fluid line engaging mechanism and a second engagement mechanism. The fluid line engaging mechanism is capable of engaging a fluid line to retain the fluid line in a substantially stationary relationship thereto. The second engagement mechanism is attached to the fluid line engaging mechanism. The second engagement mechanism is capable of engaging the first engagement mechanism.

### REFERENCE TO RELATED APPLICATION

The application claims priority to U.S. Provisional Application No. 61/685,004, which was filed on Mar. 9, 2012, the contents of which are incorporated herein by reference.

### FIELD OF THE INVENTION

The invention relates generally to supports for medical devices. More particularly, the invention relates to animal medical fluid line harnesses.

### BACKGROUND OF THE INVENTION

There are many situations where it is necessary to inject fluid into an animal. In contrast to humans where it can be explained to the human that the portion of the human's body where the fluid line enters the person's body must remain relatively stationary to prevent the needle from being dislodge from the body, it is not possible to make such an explanation to the animal.

Merely holding the line at a distance from where the fluid enters the animal is often not an acceptable option because the movement of the animal can be unpredictable and such unpredictable movements could lead to the needle being dislodged from the animal.

One technique to prevent the needle from being dislodged is to immobilize the animal while the fluid is being administered. One option for immobilizing the animal is to put the animal in a restraint. Such a restraint can cause significant trauma to the animal. Another option is for a person to hold the animal while the fluid is being administered.

While this option is less traumatic than the restraint, it limits the person's ability to perform other tasks such as turn on the fluid line and/or monitor the fluids being administered. These tasks can be particularly burdensome when fluid needs to be administered to multiple animals such as at a veterinary clinic.

### SUMMARY OF THE INVENTION

An embodiment of the invention is directed to an animal fluid line holder that includes an animal attachment portion and a fluid line attachment portion. The animal attachment portion comprises an elongated section, a fastening mechanism that is capable of engaging opposite ends of the elongated section and a first engagement mechanism attached to the elongated section.

The fluid line attachment portion includes a fluid line engaging mechanism and a second engagement mechanism. The fluid line engaging mechanism is capable of engaging a fluid line to retain the fluid line in a substantially stationary relationship thereto. The second engagement mechanism is attached to the fluid line engaging mechanism. The second engagement mechanism is capable of engaging the first engagement mechanism.

Another embodiment of the invention is directed to a method of retaining a fluid line in a desired position with respect to an animal to which fluid is being administered to the animal through the fluid line. An animal attachment portion is provided that comprises an elongated section and a first engagement mechanism attached to the elongated section.

The animal attachment portion is extended around a body of an animal. A fluid line attachment portion is attached to a fluid line with a fluid line engaging mechanism. The fluid line engaging mechanism retains the fluid line in a substantially stationary relationship thereto. The fluid line attachment portion is attached to the first engagement with a second engagement mechanism that is attached to the fluid line engaging mechanism.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. The elements of the drawings are not necessarily to scale relative to each other. Like reference numerals designate corresponding similar parts.

FIG. 1 is a top view of an animal medical line holder according to an embodiment of the invention.

FIG. 2 is a bottom view of a fluid line strap.

FIG. 3 is a side view of a fluid line with adhesive hook tape attached thereto.

FIG. 4 is a side view of the fluid line with adhesive hook tape attached to the fluid line strap.

FIG. 5 is a perspective view of the animal medical line holder used to retain a fluid line with respect to an animal.

### DETAILED DESCRIPTION OF THE INVENTION

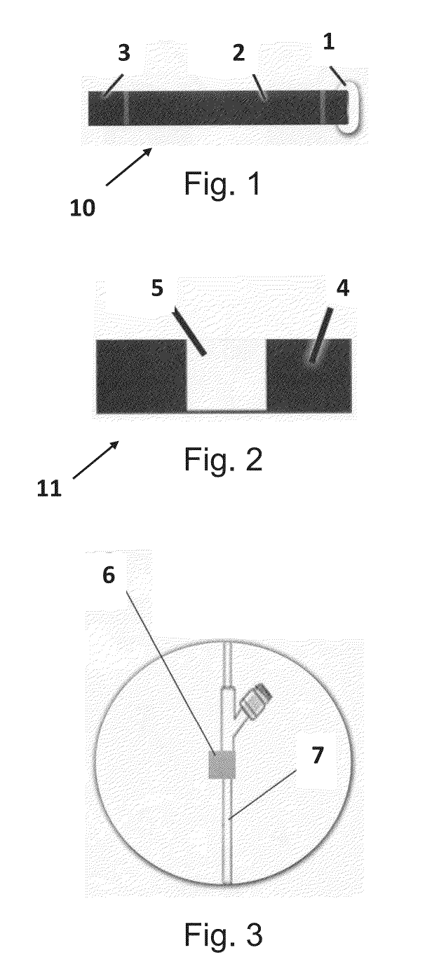

FIG. 1 shows an animal fluid line holder 10 that consists of a buckle 1, a loop tape 2 and a hook tape 3. The buckle 1 is attached to one end of the loop tape 2. A short strip of hook tape 3 is attached to an opposite end of the loop tape 2 as the buckle 1.

The buckle 1 is sufficiently wide enough for the loop tape 2 to pass through, such as about 2 inches. The loop tape 2 is sufficiently long enough to fit all the way around the animal and the width is proportional to the length of the animal, such as 10 about inches long and about 2 inches wide. The hook tape 3 is sufficiently long enough to grab a hold of the loop tape 2, such as about 2 inches long and about 2 inches wide.

FIG. 2 shows a fluid line strap 11 that is made up of hook tape 4 with a shorter piece of loop tape 5 attached at the center of the hook tape 4. The hook tape 4 is sufficiently long enough and wide enough to grab the loop tape from FIG. 1, such as about 6 inches long and about 2 inches wide. The loop tape 5 is in proportion to the adhesive hook tape 6, such as about 2 inches long and about 2 inches wide.

FIG. 3 shows an adhesive hook tape 6 that is wrapped around a fluid line 7 so the adhesive hook tape 6 creates a flat patch that can attach to the loop tape 2 and the loop tape 5. The adhesive hook tape 6 fits between the animal fluid line holder 10 and the fluid line strap.

The hook tape 6 is sufficient in length and width that it will hold the loop tape, such as about 2 inches long and about 2 inches wide. The adhesive hook tape 6 is secured around the fluid line 7 at a location based on the size of the animal, placement of the body strap and location of the needle insertion, such as 5 inches from the needle end of the fluid line 7.

The construction details of the invention to as hook and loop tape may be made of Velcro or any other material which can bond to itself. In certain embodiments, it is advantageous for the fastener to releasable bond to itself such that the components may be reused. Alternatively, other releasable fasteners such as snaps may be used.

The buckle 1 could be made of plastic, wood, metal or any other sufficiently strong material. Further, the various components of the invention can be made of different materials.

In operation, place the animal fluid line holder 10 around desired area of animal, such as their mid-section, ensuring loop side is facing outward. Place hook end 3 through the buckle 1, fold back over buckle so the hook surface 3 attaches to loop surface 2 making sure the entire body strap is secured firmly around animal.

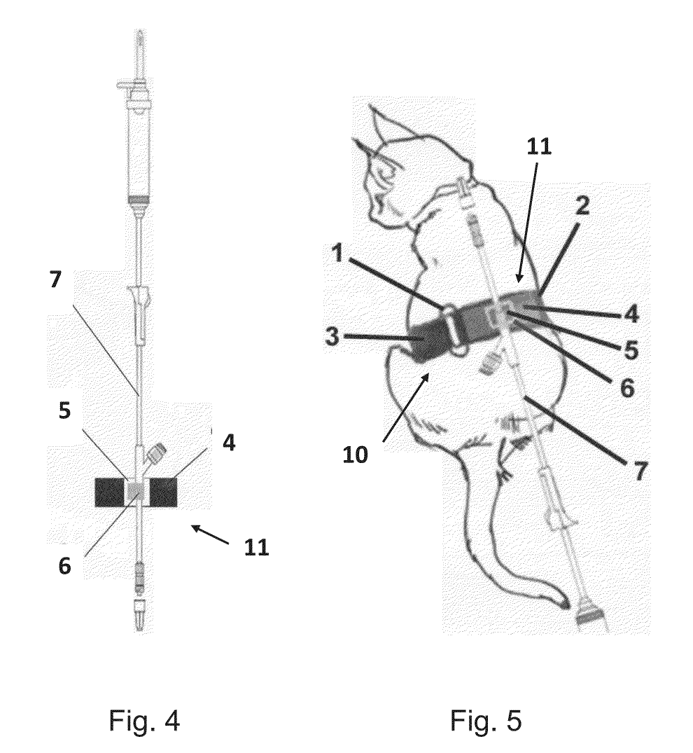

Next, the adhesive hook tape 6 is placed on the fluid line strap 11 so that the alignment is as shown in FIG. 4. The joined components are then moved into engagement with the animal as illustrated in FIG. 5.

In the preceding detailed description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present invention. The preceding detailed description, therefore, is not to be taken in a limiting sense, and the scope of the present invention is defined by the appended claims.

It is contemplated that features disclosed in this application, as well as those described in the above applications incorporated by reference, can be mixed and matched to suit particular circumstances. Various other modifications and changes will be apparent to those of ordinary skill.

1. An animal fluid line holder comprising:
an animal attachment portion that comprises:
an elongated section;
a fastening mechanism that is capable of engaging opposite ends of the elongated section; and
a first engagement mechanism attached to the elongated section; and
a fluid line attachment portion comprising:
a fluid line engaging mechanism that is capable of engaging a fluid line to retain the fluid line in a substantially stationary relationship thereto; and
a second engagement mechanism attached to the fluid line engaging mechanism, wherein the second engagement mechanism is capable of engaging the first engagement mechanism.

2. The animal fluid line holder of claim 1, wherein the fastening mechanism comprises:
a loop attached to a first end of the elongated section;
a third engagement mechanism attached to a second end of the elongated section; and
a fourth engagement mechanism attached to the elongated section intermediate the first end and the second end, wherein the third engagement mechanism is capable of engaging the fourth engagement mechanism.

3. The animal fluid line holder of claim 2 wherein the third engagement mechanism and the fourth engagement mechanism are capable of releasably engaging each other.

4. The animal fluid line holder of claim 3, wherein the third engagement mechanism is a hook fastener and wherein the fourth engagement mechanism is a loop fastener.

5. The animal fluid line holder of claim 1, wherein the first engagement mechanism and the second engagement mechanism are capable of releasably engaging each other.

6. The animal fluid line holder of claim 5, wherein the first engagement mechanism is a hook fastener and wherein the second engagement mechanism is a loop fastener.

7. The animal fluid line holder of claim 1, wherein the fluid line engagement mechanism is an adhesive.

8. The animal fluid line holder of claim 1, wherein the fluid line engagement mechanism is a slip-resistant material.

9. The animal fluid line holder of claim 1, wherein the fluid line is capable of delivering subcutaneous fluid to the animal.

10. The animal fluid line holder of claim 1, wherein the animal attachment portion is adapted for use on a feline or canine animal.

11. A method of retaining a fluid line in a desired position with respect to an animal to which fluid is being administered to the animal through the fluid line, wherein the method comprises:
providing an animal attachment portion that comprises an elongated section and a first engagement mechanism attached to the elongated section;
extending the animal attachment portion around a body of an animal;
attaching a fluid line attachment portion to a fluid line with a fluid line engaging mechanism, wherein the fluid line engaging mechanism retains the fluid line in a substantially stationary relationship thereto;
attaching the fluid line attachment portion to the first engagement with a second engagement mechanism that is attached to the fluid line engaging mechanism.

12. The method of claim 1, and further comprising retaining the animal attachment portion with respect to the animal using a fastening mechanism, wherein the fastening mechanism comprises a loop attached to a first end of the elongated section, a third engagement mechanism attached to a second end of the elongated section and a fourth engagement mechanism attached to the elongated section intermediate the first end and the second end, wherein the third engagement mechanism is capable of engaging the fourth engagement mechanism.

13. The method of claim 12, wherein the third engagement mechanism and the fourth engagement mechanism are capable of releasably engaging each other.

14. The method of claim 13, wherein the third engagement mechanism is a hook fastener and wherein the fourth engagement mechanism is a loop fastener.

15. The method of claim 11, wherein the first engagement mechanism and the second engagement mechanism are capable of releasably engaging each other.

16. The method of claim 15, wherein the first engagement mechanism is a hook fastener and wherein the second engagement mechanism is a loop fastener.

17. The method of claim 11, wherein the fluid line engagement mechanism is an adhesive.

18. The method of claim 11, wherein the fluid line engagement mechanism is a slip-resistant material.

19. The method of claim 11, wherein the fluid line is capable of delivering subcutaneous fluid to the animal.

20. The method of claim 11, wherein the animal attachment portion is adapted for use on a feline or canine animal.
